(19) United States
(12) Patent Application Publication
(10) Pub. No.: US 2017/0068531 A1
(43) Pub. Date: Mar. 9, 2017

(54) METHOD OF DEPLOYING A SET OF SOFTWARE APPLICATION(S)

(71) Applicant: THALES, COURBEVOIE (FR)

(72) Inventors: Ben Youcef Ech-Chergui, Gennevilliers (FR); Ludovic Derouet, Gennevilliers (FR)

(73) Assignee: THALES, COURBEVOIE (FR)

(21) Appl. No.: 15/119,409

(22) PCT Filed: Feb. 13, 2015
(86) PCT No.: PCT/EP2015/053098

§ 371 Date: Aug. 17, 2016

(30) Foreign Application Priority Data
Feb. 17, 2014 (FR) 14 00428

(51) Int. Cl. G06F 9/445; H04L 12/24

(52) U.S. Cl. CPC G06F 8/65; G06F 8/61; H04L 41/0803

(57) ABSTRACT

The invention relates to a method for deploying a set of software application(s), wherein:
reception by the server of software application(s) to be deployed on terminals;
determination, based on the software application(s), of a deployment list by implementing the following steps via the server:
   for each operating system, selection of the software applications based on criteria relative to the compatibility between said applications and said operating system; and determination of a deployment sub-list associated with said operating system and comprising the identifiers of said selected applications;
   insertion into the deployment list of the sub-list determined for the systems of applications;
   provision of said deployment list to the terminals.

The present invention relates to a method for deploying a set of software applications in a telecommunications network comprising at least one server, telecommunications terminals and telecommunications means between said server and said terminals, including the following steps carried out by the server:
receiving a set of software applications to be deployed on the terminals;
determining, based on said set of software applications, deployment data intended for the terminals.

The terminals for example comprise mobile or fixed equipment, smart phones, tablets, laptop or desktop computers, multimedia equipment.

The need to deploy a set of software applications in particular arises in managing fleets of terminals, for example business terminals, whereof one wishes to monitor the content. In the context of such monitoring, there are mobile device management solutions or security solutions making it possible to protect the terminal's data.

Current solutions for deploying software applications are based on the use of a public application deployment system generally supplied by the publisher of the operating system of the terminal, for example the “Google Play” system, according to which each application is installed by the user of the terminal, often the administrator of the terminal fleet. Changes to the application are published on “Google Play”. “Google Play” next informs the terminals that these updates are available.

Other solutions use a proprietary management system to deploy applications on the terminals, generally implemented on the information system of the company using the solution, or at the publisher of the security solution chosen for the terminal fleet.

For example, document WO 2011162746 A1 is known relative to an application deployment determination system.

These solutions have a certain number of drawbacks.

They cause actions that are difficult for administrators or users of the terminals to accept, for example:
having a Google account to download the applications, or requiring going through the company's information systems;
asking the administrator to manage the compatibility of the applications with the operating system versions in use: the operator must check beforehand that the applications he wishes to deploy on the remote terminals are indeed compatible with the latter.

Furthermore, they cause a significant workload for the central management entity: the latter knows the list of applications and the operating system version implemented in each terminal and, for each of these terminals, performs computations from this information to generate a deployment order dedicated to the terminal, indicating the installations, deletions and updates of applications that that terminal must perform to be compliant with the set of applications defined by the administrator. The terminal next applies its specific deployment order.

Consequently, the larger the number of managed terminals is, the more processing this central entity will be required to do to manage the deployment of applications on the fleet in question.

Solutions are based on the principle where the central entity sends a notice to the terminals to inform them that a deployment order or update is available. This principle requires the central entity to know the availability of the terminals in order to ensure that they have all received the notice, thereby causing an additional workload for that entity.

There is therefore a need to reduce the drawbacks of the prior art solutions.

To that end, according to a first aspect, the invention proposes a method for deploying a set of software applications of the aforementioned type, characterized in that said data intended for the terminals comprises a deployment list determined by the server by carrying out the following steps:
for each operating system of a group of operating systems implemented on the terminals, selection of the software applications from among said set of software applications to be deployed based on criteria relative to the compatibility between said applications and operating systems; and determination of a deployment sub-list associated with that operating system and comprising the identifiers of said selected applications;
insertion into the deployment list of the sub-list determined for the systems of applications for the group;
provision of said deployment list to the terminals.

Such automated processing thus makes it possible to generate a single file that may be used by all of the terminals. The computing needs at the server level are limited.

In embodiments, the method for deploying a set of software applications according to the invention further includes one or more of the following features:
for each application selected from a sub-list associated with an operating system, the server determines whether the installation or uninstallation of the application depends on another application and in the affirmative, the server adds the identifier of said other application into the sub-list associated with the operating system, with an indication of dependency between said application and said another application;
the verification of said criteria relative to the compatibility between a given application and an operating system comprises:
   the extraction from the application of metadata indicating the operating system(s) compatible with the application; and/or
   the comparison of operating system(s) compatible with the application and a list of operating systems managed by the server; and/or
   the extraction from the application of data indicating the version of the application; and/or
   the applications and the operating systems being associated with respective security levels: the comparison between the security level of the application and the security level of the operating system;
      each operating system being associated with a mandatory security application and the applications and the operating systems being associated with respective security levels: the determination of the mandatory security application associated with the operating system, and the comparison between the security levels of the given application and the determined mandatory security application.

According to a second aspect, the present invention proposes a method for deploying a set of software applications in a telecommunications network comprising at least one server, telecommunications terminals and telecommunications means between said server and said terminals, said method comprising the following steps:
a terminal obtains, from the server, via the telecommunications means, a deployment list listing sub-lists indicating application identifiers and each associated with a respective terminal operating system of a set of terminal operating systems;
the terminal determines the applications and the operating system then installed on the terminal, compares said determined applications and the sub-list associated with said determined operating system, and based on that comparison:
   for each of the applications installed on the terminal and for which the identifier does not appear in said sub-list, the terminal uninstalls said application;
   for each of the application identifiers appearing in said sub-list, the terminal carries out the following steps:
      the terminal determines whether said application is already installed on the terminal;
      if the terminal has determined that the application is not already installed on the terminal, it downloads said application from the server (Serv_{d}) and installs the said application;
   the deployment method further includes the steps of the deployment method according to the first aspect of the invention.

In embodiments, this method for deploying a set of software applications according to the invention further includes one or more of the following features:
the sub-list associated with each operating system indicates the application identifiers each associated with an application version number, and according to which the following steps are carried out:
   if the terminal determines that the application is already installed on the terminal, it compares the version number of the installed application to the version number associated with the identifier of said application in the sub-list;
   if these compared version numbers are different, the terminal 10 downloads from the server the version of the application indicated by the version number indicated in the sub-list and installs the downloaded software application;
in a sub-list, an identifier of an application is matched with an identifier of another application, indicating that the installation or the uninstallation of said application is dependent on said other application, and wherein the terminal installs, or uninstalls, said applications in an order based on said indication.

According to a third aspect, the present invention proposes a computer program to be installed on a server intended to be implemented in a telecommunications network further comprising telecommunications terminals and telecommunications means between said server and said terminals, said program including instructions for carrying out the steps of a method according to the first aspect of the invention during an execution of the program by the processing means of the server.

According to a fourth aspect, the present invention proposes a computer program to be installed on a telecommunications terminal intended to be implemented in a telecommunications network comprising at least one server, a plurality of telecommunications terminals and telecommunications means between said server and said terminals, said program including instructions for carrying out the steps of a method according to the second aspect of the invention during an execution of the program by the processing means of the terminal.

According to a fifth aspect, the present invention proposes a server intended for a telecommunications network further comprising telecommunications terminals, said server comprising telecommunications means between said server and said terminals;

said server being suitable for receiving a set of software applications to be deployed on the terminals, to determine, based on said set of received software applications, deployment data intended for the terminals;
said server being characterized in that it is suitable, during the determination of the deployment data, for selecting, for each operating system of a group of operating systems implemented on the terminals, software applications from among said set of software applications to be deployed based on criteria relative to the compatibility between said applications and operating systems; and for determining a deployment sub-list associated with that operating system and comprising the identifiers of said selected applications;
said server being suitable for inserting, into a deployment list, sub-lists determined for the systems of applications of the group and for making said deployment list available to the terminals.

According to a sixth aspect, the present invention proposes a telecommunications terminal intended for a telecommunications network comprising at least one server, telecommunications terminals and telecommunications means between said server and said terminals;

said terminal being suitable for obtaining, from the server, via the telecommunications means, a deployment list listing sub-lists indicating application identifiers and each associated with a respective terminal operating system of a set of terminal operating systems;
said terminal being suitable for determining the applications and the operating system then installed on the terminal, comparing said determined applications and the sub-list associated with said determined operating system, and based on that comparison:
for each of the applications installed on the terminal and for which the identifier does not appear in said sub-list, uninstalling said application;
for each of the application identifiers appearing in said sub-list, taking the following steps:
   determining whether said application is already installed on the terminal;
   if the application is determined not to be already installed on the terminal, downloading said application from the server and installing said application.

These features and advantages of the invention will appear upon reading the following description, provided solely as an example, and done in reference to the appended drawings, in which:

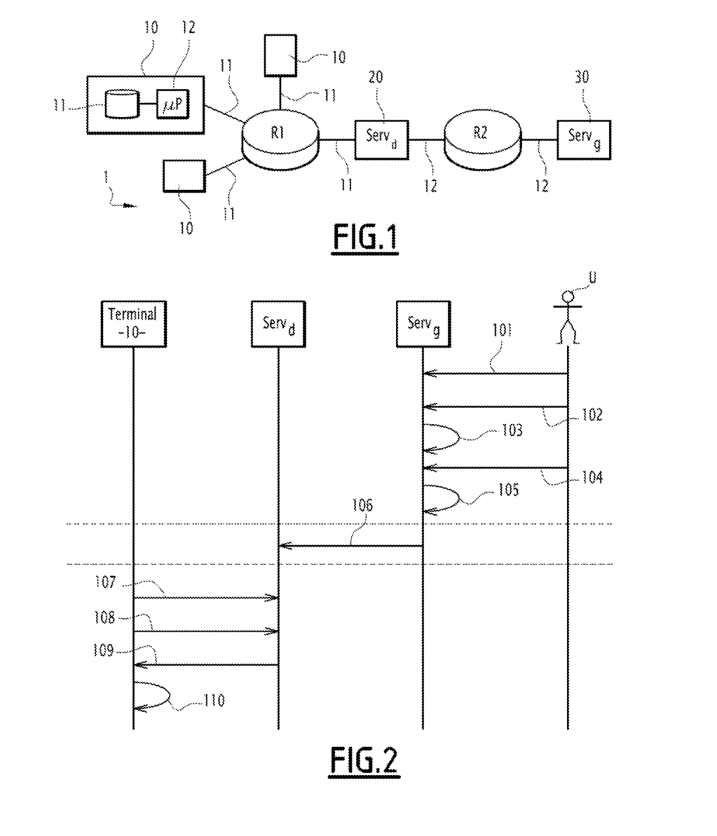

FIG. 1 shows a view of the telecommunications system in one embodiment of the invention;

FIG. 2 shows steps carried out in one embodiment of the invention;

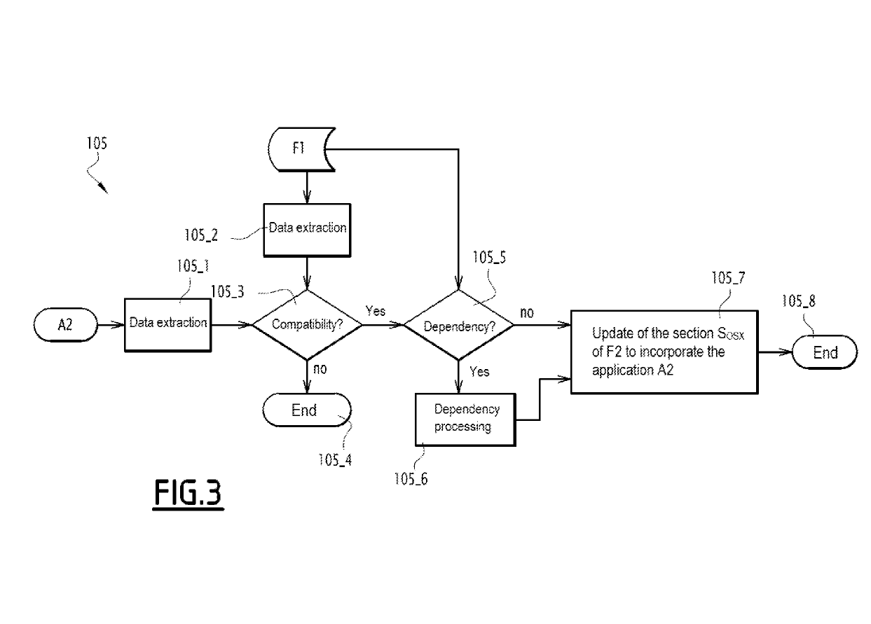

FIG. 3 shows steps carried out in one embodiment of the invention;

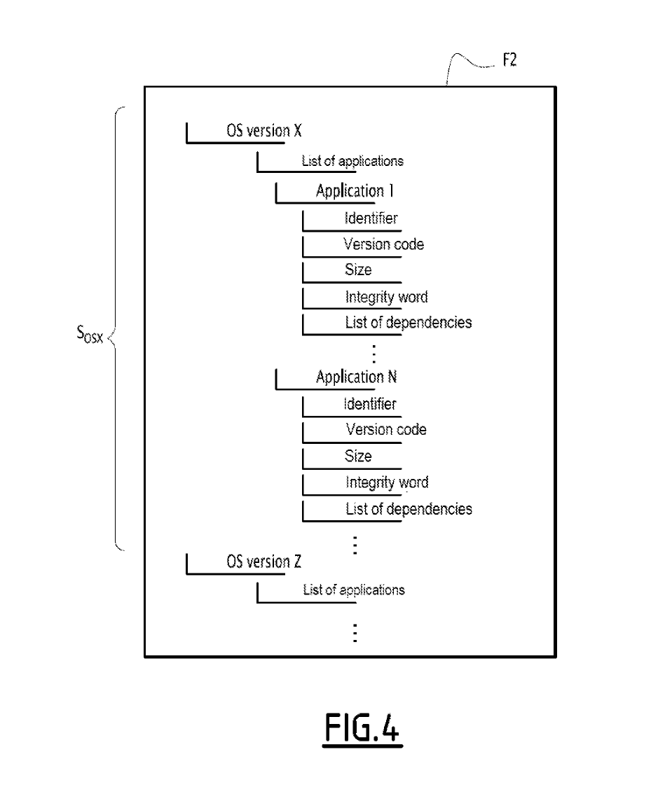

FIG. 4 is a view of part of the contents of a deployment file F2 in one embodiment of the invention.

FIG. 1 is a view of a system 100 implementing a method according to the invention.

The telecommunications system 100 includes a plurality of user terminals 10. These terminals 10 are connected by telecommunications links 11 (wired or not) to telecommunications network R1. A distribution server, Serv_{d}, is also connected to the network R1 by a telecommunications link 11.

The terminals 10 for example include mobile smart phones connected to the network R1 by wireless links 11. Terminals for example include desktop or laptop computers, etc.

Furthermore, the distribution server, Serv_{d}, and a generating server, Serv_{g}, are connected by a respective telecommunications link 12 to a telecommunications network R2.

In one embodiment, the network R1 is a public network, for example the Internet, and the network R2 is a private network, for example a company network.

Each terminal 10 in particular comprises a memory 11 and a microprocessor 12. The memory 11 is in particular suitable for storing an operating system and software applications, and for implementing them using the microprocessor 12.

In the embodiment considered here, the system 100 implements a secured environment, called security layer, implemented using mandatory security software applications.

A terminal 10 in which a mandatory security software application is installed is suitable for any software application installed on the terminal 10 and compatible with the security layer to be secured, for example in the following manner: the data generated by the software application and/or exchanged by the software application with the network R1 is encrypted, the application is protected from any fraudulent intrusion using software partitioning. This partitioning monitors the inputs and outputs of the secured application in order to prevent an unsecured third-party application from being able to interact dangerously with the secured application.

Different versions of the security layer exist in the system 100.

FIG. 2 shows steps carried out in the system 100 in one embodiment of the invention.

It will be noted that in the considered embodiment, the steps carried out by each terminal are done following the execution, on the microprocessor 12, of corresponding software instructions that were stored in the memory 11.

Likewise, the steps carried out by each server Serv_{g}, Serv_{d} are done following the execution, on the computing means of the server, of corresponding software instructions stored in a memory of the server.

In a first configuration step 101, the server Serv_{g} imports a configuration file F1, for example cryptographically protected in terms of integrity and authenticity. This file is for example provided to it by the publisher of the solution and inserted by the administrator U of the server Serv_{g}.

In the considered embodiment, this configuration file F1 indicates:
for each security layer version and operating system version managed by the generating server Serv_{g}, a list of dependencies comprising the identifiers of the applications whereof the installation on a terminal, or the uninstallation, uses other applications; and the list of dependencies, each application identifier being associated with the identifiers of said other applications;
the list of identifiers of the security applications that must be installed on the terminals on which applications must be deployed, according to the security layer considered in the system 1.

This file F1 is stored in the memory of the server Serv_{g}.

In a step 102, instructions are provided to the server Serv_{g}, for example by the administrator U requesting the import of software applications A, each associated with an application identifier and a version number.

When it receives an instruction to import an application A, the server Serv_{g} imports the software application A (via the network R2, other networks or media), then requests that it be stored on the distribution server Serv_{d}. In a step 103, the server Serv_{g} analyzes the content of this software application A and extracts data from the application, for example metadata present in its source code or in a manifest file present in the application indicating:
the operating systems (for example the type(s) of operating systems (for example Android, Windows, Linux, etc.) and the version(s) of the operating system (for example V4.0, V3.2, etc.) with which the application is compatible,
the version of the security layer with which the application is compatible.

This information is stored in the memory of the server Serv_{g}, matched with the identifier of the application A and its version number.

In a step 104, the administrator U selects at least some of the imported applications A (including one or several mandatory security applications; this selection may be made by default) and indicates this selection to the server Serv_{g}. These selected applications A define the software pack that the administrator wishes to deploy on a set T of terminals 10.

In a step 105, the server Serv_{g} then determines the content of a deployment list corresponding to the defined software pack, based on the selected applications and the associated information stored in its memory, and further based on configuration information of the file F1. In one embodiment, the software pack may contain more applications than those selected by the administrator U, since based on information contained in F1, the server Serv_{g} may be led to add applications if they are necessary for the operation of the selected applications.

This deployment list comprises, in the considered embodiment, a file F2 diagrammatically shown in FIG. 4.

In reference to FIG. 4, the deployment list F2 as determined by the generating server Serv_{g} comprises successive sections S_{OS}, each section S_{OS} being associated with a respective operating system. Thus, a section S_{OSX} is associated with the operating system X. In the considered example, each operating system is characterized by the type of operating system (Windows, Linux, Android) and its version.

Each section associated with an operating system S_{OS} (for example the section S_{OSX}) includes a list of application identifiers A2 for elements of the software pack defined above and for each of these application identifiers, further includes, associated with said application identifier A2, a version code indicating a version number of the application, the size of the application, an integrity word allowing the terminal to perform an integrity check of the application it has downloaded, and a list of dependencies.

The step 105 implemented by the generating server Serv_{g} is now described in more detail in reference to FIG. 3.

In a step 105_1, for each application identifier A2 of the software pack successively considered, the server Serv_{g} extracts, from its memory:
the information regarding the information system(s) compatible with the application A2, and
the security layer version of the application A2.

For each of these information systems indicated as being compatible with the application A2 and considered successively, the server Serv_{g}, in a step 105_2, extracts from its memory (based on stored data from the configuration file F1 and data extracted from the mandatory applications), the security layer version of the mandatory security application compatible with this information system. This information system is referenced below as follows: operating system OS version X.

In a step 105_3, the server Serv_{g} compares the security layer version of the application A2 and the security layer version of the mandatory security application compatible with this information system.

If these two security layer versions are different, the application A2 in the considered version is not added to the section of the file F2 associated with the operating system OS version X (step 105_4) and the next operating system indicated as being compatible is then considered.

It will be noted that in one embodiment of the invention, if the operating system version X is compatible with several security applications with different security layer versions, the application having the most recent version (i.e., the highest version code) will automatically be selected by the server Serv_{g} and added to the section in F2 associated with the operating system version X.

If both security layer versions are equal, the mention of the application A2 in the considered version will be added in the section S_{OSX} associated with the operating system OS version X in the file F2, but beforehand, in a step 105_5, the server Serv_{g} verifies, in the list of dependencies stored in its memory and from the configuration file F1, whether the application A2 is indicated as being dependent on other applications.

If the application A2 has no dependencies, in a step 105_7, the fields relative to the application A2 are entered in the section of the file F2 associated with the operating system OS version X: application identifier, version code, size, integrity word.

If the application A2 is indicated as being dependent on other applications, the identifiers of said other applications on which A2 depends are entered in the “list of dependencies” field associated with the application A2 in the section S_{OSX} of the file F2 associated with the operating system OS version X, and the other fields relative to the application A2 (application identifier, version code, size, integrity word) are entered in the section S_{OSX} of the file F2 are also entered [sic].

Once these operations have been performed for each application A2 of the software pack (and for each operating system compatible with the application A2), the step 105 is stopped in a step 105_8.

In a step 106, the deployment list F2 is sent by the generating server Serv_{g} to the distribution server Serv_{d} via the links 12 and the network R2 to be made available to the terminals 10.

According to the embodiments, information defining the set T of terminals 10 (for example, the set of terminals of a given company) for which that list is intended are also sent (to the server Serv_{d}) matched with the deployment list F2. The generating server Serv_{g} provides the deployment list F2 for a given set T or for a single terminal 10. Beforehand, the server Serv_{g} provides the definition of the set(s) T to the distribution server Serv_{g}, which results in the creation of files (directories) storing generic data for each set T and files specific to each terminal 10.

The distribution server Serv_{d} then stores this new deployment list F2 associated with the terminals 10, if applicable with the information defining the set T of terminals 10.

Thus, the generating server Serv_{g} has incorporated, into the generated file F2, the applications of the software pack defined by the administrator U and that met the following 2 criteria, according to which such an application must be:
compatible with an operating system (version and type) with which a mandatory application is compatible; and
such that the security layer version of the application is compatible with the security layer version of the mandatory application

The deployment list comprises sub-lists respectively associated with each operating system managed by the system 100 according to the invention. Each sub-list lists by application identifiers of the pack selected for the operating system in question and associated data.

Each terminal 10 is suitable so as, regularly (for example once per day), via the telecommunications links 11 and the network R1, to authenticate itself, and to establish a communication with the distribution server Serv_{d} so as to download a new deployment list F2 that would be available on the server and next carry out actions based on that new deployment list.

These steps are outlined below for any terminal 10.

In a step 107, the terminal 10, via the telecommunications links 11 and the network R1, establishes a communication with the server Serv_{d} and requests a connection to the distribution server Serv_{d}, via a secured mutual authentication, for example a cryptographic authentication.

Then, once the authentication is done, in a step 108, the terminal 10 exchanges with the distribution server Serv_{d} and determines, based on these exchanges, whether the deployment list F2 then made available on the server Serv_{d} for the terminals 10 has already been downloaded by the terminal 10.

In the affirmative, the communication between the terminal 10 and the distribution server Serv_{d} is ended.

If not, in a step 109, the deployment list F2 is downloaded by the terminal 10 from the distribution server Serv_{d} (if applicable, this download is only authorized after the server Serv_{d} has also verified that said terminal 10 is indeed part of the set T of terminals 10 corresponding to this deployment list F2).

In a step 110, the terminal 10 uses the downloaded deployment list F2. In particular carries out the following processing:
for each software application, hereinafter called A₁₀, installed on the terminal 10: if A₁₀ is not listed in this section S_{OSX} of in [sic] the deployment list F2 (X indicating the version and the type of operating system) that corresponds to the operating system X implemented by the terminal 10, then the terminal 10 uninstalls the software application A₁₀;
for each software application A2 listed in the section SOSX, the terminal performs actions i/ to iii/:
i/ the terminal determines whether the application A2 is already installed on the terminal 10.
ii/ if yes, the terminal compares the version of the installed application A2 and that indicated by the version code of A2 indicated in this section S_{OSX}. Following this comparison: if these compared versions are identical, there is no action relative to A2 to be taken by the terminal 10; and if these compared versions of A2 are different, the terminal 10 downloads, from the server Serv_{d}, the version of A2 indicated by the version code of A2 indicated in the section S_{OSX} and replaces the installed software application A2 with the downloaded one (traditionally via a software update procedure).
iii/ if the terminal 10 has determined that the application A2 is not already installed on the terminal 10, it downloads, from the server Serv_{d}, the application A2 in the version indicated in the section S_{OSX}, and installs it while complying with the software dependencies of A2 indicated in the list of dependencies of the application A2 in the section S_{OSX}: if the application A3 is identified in the list of dependencies of the application A2, the application A3 is downloaded and installed by the terminal 10 before A2.

In the considered embodiment, the terminals 10 are suitable for regularly querying the distribution server Serv_{d} regarding the existence of a new deployment file F2. In another embodiment, the terminals 10 are notified of the existence of a new deployment file F2 to be downloaded by a message, or a new deployment file F2 is sent to them directly.

The deployment list (file F2) thus includes, for each considered type of operating system, in each considered version, a list of applications extracted from the set E of applications indicated by the administrator.

Thus, for two operating system versions considered in the file F2, the list of applications determined for the first version of the operating system may differ from that determined for the second version of the operating system for the following reasons:
an application chosen by the administrator is not compatible with one of the two operating system versions;
an application is not compatible with the security layer corresponding to one of the versions of the operating system.

This deployment list (file F2) does not include any command in the considered embodiment. It provides the list of applications defined by the administrator in the set of applications E.

The deployment list F2 has been formed by the server Serv_{g} coherently, i.e., the applications incompatible with the security layer of the mandatory security applications are not present.

Thus, the invention makes it possible to simplify a deployment of applications on a fleet of terminals. It systematically and automatically resolves the following technical problems:
compatibility of applications with the operating systems of the terminals and the versions of those operating systems;
compatibility and coherence of the applications with respect to the security layers that they use;
taking account of dependencies between applications.

The invention further makes it possible to increase performance and decrease the necessary processing resources.

The processing operations are in fact distributed between a central entity (above, the generating server Serv_{g}) and the mobile terminals. The server Serv_{g} is responsible for the list of applications, coherence checks and producing the generated deployment list (in the case above, the file F2), while each terminal, from the shared file F2, performs processing operations to deduce the necessary actions therefrom to be carried out based on the state of the terminal.

The deployment list generated via the file F2 is unique (the server Serv_{g} only generates a single file F2 for a set of terminals, and not one file per terminal). The file F2 that a terminal uses has not been established by the server based on the state of that particular terminal, in particular has been established independently from the applications and operating systems specifically implemented on that particular terminal.

The embodiment described in reference to the above figures uses two servers Serv_{g} and Serv_{d} connected via a network R2. This is only one possible embodiment of the invention among others. In other embodiments, for example, a single server is used to carry out the operations performed by these servers Serv_{g} and Serv_{d}.

In the embodiment described above in reference to the figures, a deployment has been considered taking account of issues related to a secured environment implemented in the system. The invention may of course be used outside such a security environment.

1. A method for deploying a set of software applications in a telecommunications network comprising at least one server (Serv_{g}, Serv_{d}), telecommunications terminals and telecommunications means between said server and said terminals, including the following steps carried out by the server:
receiving a set of software applications to be deployed on the terminals;
determining, based on said set of software applications, deployment data intended for the terminals;
wherein said data intended for the terminals comprises a deployment list (F2) determined by the server by carrying out the following steps:
for each operating system of a group of operating systems implemented on the terminals, selection of the software applications from among said set of software applications to be deployed based on criteria relative to the compatibility between said applications and operating system; and determination of a deployment sub-list associated with that operating system and comprising the identifiers of said selected applications;
insertion into the deployment list (F2) of the sub-list determined for the systems of applications for the group;
provision of said deployment list to the terminals.

2. The method for deploying a set of software applications according to claim 1, wherein, for each application selected from a sub-list associated with an operating system, the server determines whether the installation or uninstallation of the application depends on another application and wherein in the affirmative, the server adds the identifier of said other application into the sub-list associated with the operating system, with an indication of dependency between said application and said another application.

3. The method for deploying a set of software applications according to claim 1, wherein the verification of said criteria relative to the compatibility between a given application and an operating system comprises:
the extraction from the application of metadata indicating the operating system(s) compatible with the application; and/or
the comparison of operating system(s) compatible with the application and a list of operating systems managed by the server; and/or
the extraction from the application of data indicating the version of the application; and/or
the applications and the operating systems being associated with respective security levels: the comparison between the security level of the application and the security level of the operating system;
each operating system being associated with a mandatory security application and the applications and the operating systems being associated with respective security levels: the determination of the mandatory security application associated with the operating system, and the comparison between the security levels of the given application and the determined mandatory security application.

4. A method for deploying a set of software applications in a telecommunications network comprising at least one server (Serv_{g}, Serv_{d}), telecommunications terminals and telecommunications means (10) between said server and said terminals, comprising the following steps:
a terminal obtains, from the server, via the telecommunications means, a deployment list (F2) listing sub-lists indicating application identifiers and each associated with a respective terminal operating system of a set of terminal operating systems;
the terminal determines the applications and the operating system installed on the terminal, compares said determined applications and the sub-list associated with said determined operating system, and based on that comparison:
for each of the applications installed on the terminal and for which the identifier does not appear in said sub-list, the terminal uninstalls said application;
for each of the application identifiers appearing in said sub-list, the terminal carries out the following steps:
the terminal determines whether said application is already installed on the terminal;
if the terminal has determined that the application is not already installed on the terminal, it downloads said application from the server (Serv_{d}) and installs the said application.

5. The method for deploying a set of software applications according to claim 4, wherein the sub-list associated with each operating system indicates the application identifiers each associated with an application version number, and according to which the following steps are carried out:
if the terminal determines that the application is already installed on the terminal, it compares the version number of the installed application to the version number associated with the identifier of said application in the sub-list;
if these compared version numbers are different, the terminal 10 downloads from the server (Serv_{g}) the version of the application indicated by the version number indicated in the sub-list and installs the downloaded software application.

6. A method for deploying a set of software applications according to claim 4, wherein in a sub-list, an identifier of an application is matched with an identifier of another application, indicating that the installation or the uninstallation of said application is dependent on said other application, and wherein the terminal installs, or uninstalls, said applications in an order based on said indication.

7. The method for deploying a set of software application(s) according to claim 4 and further according to claim 1.

8. A computer program to be installed on a server (Serv_{g}, Serv_{d}) intended to be implemented in a telecommunications network further comprising telecommunications terminals (10) and telecommunications means between said server and said terminals, said program including instructions for carrying out the steps of a method according to claim 1 during an execution of the program by the processing means of the server.

9. A computer program to be installed in a telecommunications terminal (10) intended to be implemented in a telecommunications network comprising at least one server, a plurality of telecommunications terminals (10) and telecommunications means between said server and said terminals, said program including instructions for carrying out the steps of a method according to claim 4 during an execution of the program by the processing means of the terminal.

10. A server (Serv_{g}, Serv_{d}) intended for a telecommunications network further comprising telecommunications terminals, said server comprising telecommunications means between said server and said terminals;
said server being suitable for receiving a set of software applications to be deployed on the terminals, to determine, based on said set of received software applications, deployment data intended for the terminals;
wherein the server is suitable, during the determination of the deployment data, for selecting, for each operating system of a group of operating systems implemented on the terminals, software applications from among said set of software applications to be deployed based on criteria relative to the compatibility between said applications and operating systems; and for determining a deployment sub-list associated with that operating system and comprising the identifiers of said selected applications;
said server being suitable for inserting, into a deployment list (F2), sub-lists determined for the systems of applications of the group and for making said deployment list available to the terminals.

11. The server according to claim 10, suitable, for each application selected from a sub-list associated with an operating system, to determine whether the installation or the uninstallation of the application depends on another application and, in the affirmative, to add the identifier of said other application into the sub-list associated with the operating system, with an indication of dependency between said application and said other application.

12. The server according to claim 10, suitable, during the verification of said criteria relative to the compatibility between a given application and an operating system, to
extract from the application, metadata indicating the operating system(s) compatible with the application; and/or
compare operating systems compatible with the application and a list of operating systems managed by the server; and/or
extract from the application data indicating the version of the application; and/or
the applications and the operating systems being associated with respective security levels: compare the security level of the application and the security level of the operating system;
each operating system being associated with a mandatory security application and the applications and the operating systems being associated with respective security levels:
determine the mandatory security application associated with the operating system, and compare the security levels of the given application and the determined mandatory security application.

13. A telecommunications terminal (10) intended for a telecommunications network comprising at least one server (Serv_{g}, Serv_{d}), telecommunications terminals (10) and telecommunications means between said server and said terminals,
said terminal being suitable for obtaining, from the server, via the telecommunications means, a deployment list (F2) listing sub-lists indicating application identifiers and each associated with a respective terminal operating system of a set of terminal operating systems;
said terminal being suitable for determining the applications and the operating system installed on the terminal, comparing said determined applications and the sub-list associated with said determined operating system, and based on that comparison:
for each of the applications installed on the terminal and for which the identifier does not appear in said sub-list, uninstalling said application;
for each of the application identifiers appearing in said sub-list, taking the following steps:
determining whether said application is already installed on the terminal;
if the application is determined not to be already installed on the terminal, downloading said application from the server (Serv_{d}) and installing said application.

14. The telecommunications terminal (10) according to claim 13, suitable, the sub-list associated with each operating system indicating application identifiers each associated with an application version number, if the terminal has determined that the application is already installed on the terminal, for comparing the version number of the installed application to that associated with the identifier of said application in said sub-list; and if these compared version numbers are different, downloading from the server (Serv_{g}) the version of the application indicated by the version number indicated in the sub-list and installing the downloaded software application.

15. The telecommunications terminal (10) according to claim 13, wherein in a sub-list, an identifier of an application is matched with an identifier of another application, indicating that the installation or the uninstallation of said application is dependent on said another application and the terminal is suitable for installing, or uninstalling, said applications in an order based on said indication.
